(19) United States
(12) Patent Application Publication
(10) Pub. No.: US 2007/0190412 A1
(43) Pub. Date: Aug. 16, 2007

(54) Non-aqueous electrolyte solution for secondary battery and non-aqueous electrolyte secondary battery

(76) Inventors: Takanobu Chiga, Kobe-shi (JP); Yoshinori Kida, Kobe-shi (JP)

Correspondence Address: KUBOVCIK & KUBOVCIK, SUITE 710, 900 17TH STREET NW, WASHINGTON, DC, 20006, US

(21) Appl. No.: 11/705,005

(22) Filed: Feb. 12, 2007

(30) Foreign Application Priority Data
Feb. 14, 2006 (JP) 2006-036481

(51) Int. Cl. H01M 10/40; H01M 4/48

(52) U.S. Cl. 429/200; 429/332; 429/231.1

(57) ABSTRACT

In a non-aqueous electrolyte secondary battery having a positive electrode, a negative electrode, and a non-aqueous electrolyte solution containing a fluorinated ester as a solvent, battery safety is improved without degrading charge-discharge characteristics. A non-aqueous electrolyte solution for a secondary battery contains a fluorinated ester represented by the chemical formula CHF₂COOR, where R is an alkyl group having 1 to 4 carbon atoms or a halogen-atom-substituted alkyl group having 1 to 4 carbon atoms. The fluorinated ester has a water content of 30 ppm or less. The solvent additionally contains a cyclic carbonic ester having an unsaturated C═C bond.

### BACKGROUND OF THE INVENTION

1. Field of the Invention

The present invention relates to non-aqueous electrolyte solutions for secondary batteries, and non-aqueous electrolyte secondary batteries.

2. Description of Related Art

In recent years, a non-aqueous electrolyte secondary battery has drawn attention as a high energy density battery. In the non-aqueous electrolyte, secondary battery, the negative electrode active material is composed of a carbon material, metallic lithium, or an alloy capable of intercalating and deintercalating lithium ions, and the positive electrode active material is composed of a lithium-transition metal composite oxide represented by the chemical formula LiMO₂ (where M is a transition, metal).

The electrolyte solution used for the non-aqueous electrolyte solution is normally an electrolyte in which a lithium salt, such as LiPF₆ and LiBF₄, is dissolved in an aprotic organic solvent. Examples of the commonly used aprotic solvent are carbonates such as propylene carbonate, ethylene carbonate, diethyl carbonate, and ethyl methyl carbonate; esters such as γ-butyrolactone and methyl acetate; and ethers such as diethoxyethane. Among them, a mixed solvent of a cyclic carbonate such as ethylene carbonate and a chain carbonate such as ethyl methyl carbonate is widely used.

The just-mentioned non-aqueous electrolyte solution, however, may undergo a reductive decomposition on the negative electrode when the battery is unusually charged, which may risk the safety of the battery. Currently, in order to cope with such an unusual condition, a protection circuit for assuring safety is provided in the battery pack so that battery voltage and current can be precisely controlled. In addition, safety measures for batteries are taken by providing the battery can with a protective function such as a PTC (Positive Temperature Coefficient) element, which serves to prevent abnormal heat generation when an excessively large current passes, or with a gas vent valve that has a current cut-off function for preventing an unusual gas pressure increase, or by selecting a material for the positive and negative electrode active materials with sufficient consideration for safety. In recent years, however, from the viewpoint of simplifying the protective functions, it has been desired to further improve battery safety by controlling the exothermic reaction between the charged negative electrode and the electrolyte solution.

To date, Japanese Published Unexamined Patent Application Nos. 8-298134 and 11-86901 have proposed the use of a fluorinated ester for the non-aqueous electrolyte solution, in order to improve safety and charge-discharge characteristics of the battery. Moreover, several researchers have proposed the use of CHF₂COOCH₃ (MFA) among fluorinated esters, to control the exothermic reaction of the electrolyte solution with metallic lithium and a charged negative electrode (see, for example, Jun-Inchi Yamaki, Ikiko Yamazaki, Minato Egashira, and Shigeto Okada, J. Power Sources, vol. 102, pp. 288-293, (2001); Kazuya Sato, Ikiko Yamazaki, Shigeto Okada, and Jun-Inchi Yamaki, Solid State Ionics, vol. 148, pp. 463-466, (2002); and Masayuki Ihara, Bui Thi Hang, Kazuya Sato, Minato Egashira, Shigeto Okada, and Jun-Inchi Yamaki, J. Electrochem. Soc., vol. 150 (11), pp. A1476-A1483, (2003)). Nevertheless, it has still been difficult to improve battery safety while assuring good charge-discharge characteristics. Moreover, Yamaki et al. and Sato et al. have reported that, although the use of CHF₂COOCH₃ is effective to control the exothermic reaction, CHF₂COOC₂H₅ is not effective, and furthermore, they have not explicitly shown the mechanism for controlling the exothermic reaction.

Thus, with the batteries that use the conventional fluorinated esters as a solvent for the non-aqueous electrolyte solution, it has been impossible to enhance safety and at the same time to ensure sufficient battery performance.

### BRIEF SUMMARY OF THE INVENTION

Accordingly, it is an object of the present invention to provide a non-aqueous electrolyte solution that improves battery safety while assuring good battery performance when used for a non-aqueous electrolyte secondary battery, and to provide a non-aqueous electrolyte secondary battery that employs such a non-aqueous electrolyte solution.

In order to accomplish the foregoing and other objects, the present invention provides a non-aqueous electrolyte solution for a secondary battery comprising: a lithium salt as an electrolyte; and a solvent containing a cyclic carbonic ester having an unsaturated C═C bond, and a fluorinated ester having a water content of 30 ppm or less and represented by the chemical formula CHF₂COOR, where R is an alkyl group having 1 to 4 carbon atoms or a halogen-atom-substituted alkyl group having 1 to 4 carbon atoms.

According to the present invention, safety of the non-aqueous electrolyte secondary battery is improved without degrading the charge-discharge characteristics, by using the non-aqueous electrolyte solution containing the cyclic carbonic ester having an unsaturated C═C bond, and the fluorinated ester having a water content of 30 ppm or less and represented by the chemical formula CHF₂COOR, where R is an alkyl group having 1 to 4 carbon atoms or a halogen-atom-substituted alkyl group having 1 to 4 carbon atoms.

### BRIEF DESCRIPTION OF THE DRAWING

FIG. 1 is a graph illustrating the results of C—V measurement for an electrolyte solution F employing a fluorinated ester having a water content of 3.3 ppm and an electrolyte solution J employing a fluorinated ester having a water content of 48 ppm.

### DETAILED DESCRIPTION OF THE INVENTION

The non-aqueous electrolyte solution according to the present invention contains, in the solvent, a fluorinated ester having a water content of 30 ppm or less and represented by the chemical formula CHF₂COOR, where R is an alkyl group having 1 to 4 carbon atoms or a halogen-atom-substituted alkyl group having 1 to 4 carbon atoms, and a cyclic carbonic ester having an unsaturated C═C bond. The non-aqueous electrolyte solution improves battery safety and at the same time ensures good battery performance. This is believed to be because, by using, as a solvent, the fluorinated ester represented by the chemical formula CHF₂COOR, where R is an alkyl group having 1 to 4 carbon atoms or a halogen-atom-substituted alkyl group having 1 to 4 carbon atoms, the CHF₂COOR undergoes a reductive decomposition on the negative electrode during the initial charging, and consequently a good surface film forms on the negative electrode. This formation of the surface film serves to lessen the exothermic reaction between the charged negative electrode and the electrolyte solution, and thus improves battery safety.

Here, in order to form a good surface film, the CHF₂COO group is indispensable, but the alkyl group R derived from alcohol is not particularly limited. That said, if the number of the carbon atoms in the end group R is large, the viscosity increases and the load characteristics degrade. For this reason, it is preferable that the end group R have 1 to 4 carbon atoms. Especially preferable for the end group R are the CH₃ group and the C₂H₅ group.

It is preferable that the fluorinated ester represented by the chemical formula CHF₂COOR, where R is an alkyl group having 1 to 4 carbon atoms or a halogen-atom-substituted alkyl group having 1 to 4 carbon atoms, be sufficiently dehydrated before being used as a solvent so that it has a water content of 30 ppm or less. This is because, when commonly used LiPF₆ is selected as an electrolyte and water is contained in the fluorinated ester in an amount exceeding the foregoing range, a reaction may be caused between the CHF₂COOR and HF, which is produced by decomposition of the LiPF₆, and consequently a good surface film may not be formed. Therefore, it is preferable that the fluorinated ester have a water content of 30 ppm or less, and more preferably 10 ppm or less.

In the present invention, the water content of the fluorinated ester may be obtained by the Karl Fischer technique. The water content of the fluorinated ester in the present invention may be controlled by the following method, for example. First, using a distillation column replaced by argon gas, a fluorinated ester is heated at atmospheric pressure, and the fluorinated ester is recovered by a condenser. At this time, it is preferable to use a distillate that is recovered at the time when the distillation temperature is at about the boiling point of the fluorinated ester. For example, when the fluorinated ester is CHF₂COOCH₃ (MFA), its boiling point is about 85° C. When the fluorinated ester is CHF₂COOC₂H₅ (EFA), its boiling point is about 97° C. Therefore, in the cases of MFA and EFA, the fluorinated esters distilled at about the respective temperatures should be used. The fluorinated ester thus produced is then dehydrated with a 3A-type molecular sieve, and thus, a fluorinated ester having a water content of 30 ppm or less can be obtained. It should be noted, however, that the method of controlling the water content of the fluorinated ester in the present invention is not limited to the just-described method.

In the non-aqueous electrolyte solution of the present invention, it is preferable that the fluorinated ester represented by the chemical formula CHF₂COOR, where R is an alkyl group having 1 to 4 carbon atoms or a halogen-atom-substituted alkyl group having 1 to 4 carbon atoms be contained in an amount of 20 volume % or greater, more preferably 40 volume % or greater, of the total volume of the solvent. If the content of the fluorinated ester is lower than these ranges, there may be cases in which the surface film is not sufficiently formed on the negative electrode surface and the exothermic reaction between the negative electrode and the electrolyte solution is not lessened.

In the present invention, the fluorinated ester represented by the chemical formula CHF₂COOR, where R is an alkyl group having 1 to 4 carbon atoms or a halogen-atom-substituted alkyl group having 1 to 4 carbon atoms, partially undergoes a reductive decomposition on the negative electrode during the initial charging and consequently forms a good surface film that lessens the exothermic reaction with the electrolyte solution. However, it lowers the initial charge-discharge efficiency and leads to degradation in battery performance. For this reason, in the present invention, the cyclic carbonic ester having an unsaturated C═C bond is added to the non-aqueous electrolyte solution as an addition agent such that the surface film originating from the fluorinated ester is not excessively formed.

Examples of the cyclic carbonic ester having an unsaturated C═C bond include vinylene carbonate, 4,5-dimethylvinylene carbonate, 4,5-diethylvinylene carbonate, 4,5-dipropylvinylene carbonate, 4-ethyl-5-methylvinylene carbonate, 4-ethyl-5-propylvinylene carbonate, 4-methyl-5-propylvinylene carbonate, vinyl ethylene carbonate, and divinyl ethylene carbonate. Among these, vinylene carbonate and vinyl ethylene carbonate are preferable in that they allow a good surface film to form on the negative electrode. In addition, in order to form the surface film originating from the CHF₂COO group but to prevent the surface film from being formed excessively, it is preferable that the reduction potential of the cyclic carbonic ester having an unsaturated C═C bond be close to the reduction potential of the CHF₂COOR. Accordingly, because CHF₂COOR undergoes a reductive decomposition at about 1 V (vs. Li/Li⁺), it is preferable that the cyclic carbonic ester having an unsaturated C═C bond have a reduction potential in the vicinity of from 0.8 V to 1.2 V (vs. Li/Li⁺). If the reduction potential is lower than the above range, the decomposition of the CHF₂COOR excessively occurs, and the charge-discharge characteristics may degrade although the surface film originating from the CHF₂COO group forms. On the other hand, if the reduction potential is higher than the above range, there may be cases in which the decomposition of CHF₂COOR is completely hindered and the surface film originating from the CHF₂COO group is not formed. For this reason, it is particularly preferable that the cyclic carbonic ester having an unsaturated C═C bond comprise vinyl ethylene carbonate, which has a reduction potential in the vicinity of about 1 V (vs. Li/Li⁺).

It is preferable that the proportion of the cyclic carbonic ester having an unsaturated C═C bond in the non-aqueous electrolyte solution be 0.1 to 10 parts by weight, more preferably 0.5 to 5 parts by weight, with respect to 100 parts by weight of the electrolyte solution. If the content of the cyclic carbonic ester is too low, the decomposition of the fluorinated ester excessively occurs on the negative electrode, and the charge-discharge characteristics may degrade although the surface film derived from the CHF₂COO group forms and the exothermic reaction with the electrolyte solution lessens. On the other hand, if the content of the cyclic carbonic ester having an unsaturated C═C bond is too high, the decomposition of the fluorinated ester is completely hindered, so that the surface film derived from the CHF₂COO group may not be formed and the exothermic reaction between the charged negative electrode and the electrolyte solution may not be lessened.

In addition to the cyclic carbonic ester having an unsaturated C═C bond and the fluorinated ester represented by the chemical formula CHF₂COOR, where R is an alkyl group having 1 to 4 carbon atoms or a halogen-atom-substituted alkyl group having 1 to 4 carbon atoms, examples of the solvent usable in the present invention include: cyclic carbonic esters such as ethylene carbonate, propylene carbonate, 1,2-butylene carbonate, and 2,3-butylene carbonate; cyclic esters such as γ-butyrolactone and propane sultone; chain carbonic esters such as ethyl methyl carbonate, diethyl carbonate, and dimethyl carbonate; chain ethers such as 1,2-dimethoxyethane, 1,2-diethoxyethane, diethyl ether, and ethyl methyl ether; as well as methyl acetate, ethyl acetate, propyl acetate, methyl propionate, ethyl propionate, tetrahydrofuran, 2-methyltetrahydrofuran, 1,4-dioxane, and acetonitrile.

The non-aqueous electrolyte secondary battery according to the present invention comprises a positive electrode, a negative electrode, and a non-aqueous electrolyte solution for a secondary battery. The non-aqueous electrolyte solution contains a cyclic carbonic ester having an unsaturated C═C bond and a fluorinated ester having a water content of 30 ppm or less and represented by the fluorinated ester represented by the chemical formula CHF₂COOR, where R is an alkyl group having 1 to 4 carbon atoms or a halogen-atom-substituted alkyl group having 1 to 4 carbon atoms.

The negative electrode active material in the present invention may be any material as long as it is capable of intercalating and deintercalating lithium. Examples include: metallic lithium; lithium alloys such as lithium-aluminum alloy, lithium-lead alloy, lithium-silicon alloy, and lithium-tin alloy; silicon and silicon alloys; carbon materials such as graphite, coke, and sintered organic materials; and metal oxides such as SnO₂, SnO, and TiO₂ that show a lower potential than the positive electrode active material. Among them, carbon materials are preferable from the viewpoint that they allow a good quality surface film to form on the negative electrode surface with the non-aqueous electrolyte solution containing the fluorinated ester represented by the chemical formula CHF₂COOR, where R is an alkyl group or a halogen-atom-substituted alkyl group.

In particular, a carbon material having an R value (I_{D}/I_{G}) of 0.04 to 0.7, as determined from Raman spectroscopy, is preferable since good charge-discharge characteristics can be obtained. The R value (I_{D}/I_{G}) is calculated from a peak intensity (I_{D}) at peak P_{D} centered at about 1360 cm⁻¹ and a peak intensity (I_{G}) at peak P_{G} centered at about 1580 cm⁻¹, which are determined by laser Raman spectroscopy using an argon laser having a wavelength of 514.5 nm. The peak centered at about 1580 cm⁻¹ originates from a layered structure with a hexagonal symmetry that is close to the graphite structure, while the peak centered at about 1360 cm⁻¹ originates from a disordered amorphous structure which exists locally in carbon. Accordingly, the higher the proportion of the amorphous portion of the carbon material in the surface layer, the greater the R value (I_{D}/I_{G}). When the crystallinity of the carbon material in the surface is lower, the formed surface film tends to be more uniform and denser, and therefore, it becomes possible to prevent an excessive decomposition of the fluorinated ester on the negative electrode. Thus, it is preferable that the carbon material have an R value (I_{D}/I_{G}) of 0.04 or greater, as determined from Raman spectroscopy. On the other hand, if the R value (I_{D}/I_{G}) is greater than 0.7, the surface is exceedingly in an amorphous condition, so there is a risk of degradation in the charge-discharge efficiency. For these reasons, it is preferable that the R value (I_{D}/I_{G}) be in the range of from 0.04 to 0.7, and more preferably in the range of from 0.06 to 0.5.

The above-described negative electrode materials may be used in a mixture obtained by kneading them with a binder agent such as polytetrafluoroethylene (PTFE), poly(vinylidene fluoride) (PVdF), and styrene-butadiene rubber (SBR), by common techniques.

The positive electrode active material used in the present invention is not particularly limited as long as it is usable as a positive electrode active material for non-aqueous electrolyte secondary batteries. Examples include a lithium-containing transition metal oxide having a layered structure or a spinel structure, and a lithium-containing transition metal phosphate having an olivine structure. Among them, a lithium-containing transition metal oxide having a layered structure is preferable from the viewpoint of high energy density, and particularly, lithium cobalt oxide is preferable. These materials may be used in a mixture with a conductive agent, such as acetylene black or carbon black, and with a binder agent, such as polytetrafluoroethylene (PTFE) or poly(vinylidene fluoride) (PVdF)

The solute of the non-aqueous electrolyte solution used in the present invention may be any solute that has conventionally been used for non-aqueous electrolyte secondary batteries, such as a lithium salt. Examples of the lithium salt include LiPF₆, LiBF₄, LiCF₃SO₃, LiClO₄, LiN(C₂F₅SO₂)₂, LiN(CF₃SO₂) (C₄F₉SO₂), LiC(CF₃SO₂)₃, LiC(C₂F₅SO₂)₃, LiB(C₂O₄)F₂, Li[B(C₂O₄)F₂], Li[P(C₂O₄)F₄], Li[PC₂O₄)₂F₂, and Li[P(C₂O₄)F₄].

Hereinbelow, the present invention is described in further detail based on examples thereof. It should be construed, however, that the present invention is not limited to the following examples but various changes and modifications are possible without departing from the scope of the invention.

Preparation of Negative Electrode

Graphite (R value=0.08) as a negative electrode active material, SBR as a binder agent, and an aqueous solution in which carboxymethylcellulose as a thickening agent is dissolved were weighed so that the weight ratio of the active material and the binder agent and the thickening agent became 97.5:1.5:1, and thereafter kneaded to prepare a negative electrode slurry. The prepared slurry was applied onto a copper foil, serving as a current collector, and then dried. The resultant material was pressure-rolled using pressure rollers. Thus, a negative electrode was prepared.

Preparation of Positive Electrode

LiCoO₂ as a positive electrode active material, carbon as a conductive agent, and an N-methyl-2-pyrrolidone solution in which polyvinylidene fluoride as a binder agent is dissolved, were mixed so that the weight ratio of the active material and the conductive agent and the binder agent became 95:2.5:2.5, and thereafter kneaded to prepare a positive electrode slurry. The prepared slurry was applied onto an aluminum foil, serving as a current collector, and then dried. Thereafter, the resultant material was pressure-rolled using pressure rollers. Thus, a positive electrode was prepared.

Preparation of Evaluation Cell

The prepared negative electrode was cut out to form a working electrode. A rolled lithium plate having a predetermined thickness was cut out to form a counter electrode. A polyethylene separator was interposed between the working electrode and the counter electrode, and these were enclosed in a battery can together with an electrolyte solution having one of the later-described predetermined compositions in a glove box under an Ar (argon) atmosphere, to thus prepare an evaluation cell.

Preparation of Cylindrical Battery

The negative electrode and the positive electrode prepared in the above-described manner were wound with a polyethylene separator interposed therebetween, to prepare a wound assembly. Next, the wound assembly was enclosed in a battery can together with an electrolyte solution having one of the later-described predetermined compositions in a glove box under an Ar atmosphere, to prepare a 18650 size cylindrical non-aqueous electrolyte secondary battery.

Preparation of Three-Electrode Test Cell

A beaker cell was employed to prepare a three-electrode test cell using an electrolyte solution having one of the later-described predetermined compositions. The working electrode was made by cutting out the negative electrode prepared in the foregoing manner, while the counter electrode and the reference electrode were made by cutting out a rolled lithium plate having a predetermined thickness.

Preparation of Electrolyte Solution

### EXAMPLE 1

CHF₂COOCH₃ (MFA) having a water content of 3.3 ppm was used as the solvent, and LiPF₆ was dissolved therein at a concentration of 1 mole/liter. Then, to 100 parts by weight of the resultant solution, 2 parts by weight of vinylene carbonate (VC) and 2 parts by weight of vinyl ethylene carbonate (VEC) were added as addition agents, to thus prepare a non-aqueous electrolyte solution A. Using the non-aqueous electrolyte solution thus prepared, an evaluation cell and a cylindrical battery were fabricated in the above-described manner.

### EXAMPLE 2

A non-aqueous electrolyte solution B was prepared in the same manner as described in Example 1, except that CHF₂COOC₂H₅ (EFA) having a water content of 2.7 ppm was used as a solvent, and using the electrolyte solution thus prepared, an evaluation cell and a cylindrical battery were fabricated in the above-described manner.

### EXAMPLE 3

A non-aqueous electrolyte solution C was prepared in the same manner as described in Example 1, except that 2 parts by weight of vinylene carbonate (VC) alone was added as the addition agent, and using the electrolyte solution thus prepared, an evaluation cell was fabricated in the above-described manner.

### EXAMPLE 4

A non-aqueous electrolyte solution D was prepared in the same manner as described in Example 2, except that 2 parts by weight of vinylene carbonate (VC) alone was added as the addition agent, and using the electrolyte solution thus prepared, an evaluation cell was fabricated in the above-described manner.

### COMPARATIVE EXAMPLE 1

A non-aqueous electrolyte solution E was prepared in the same manner as described in Example 1, except that CH₃COOCH₃ (MA) was used as the solvent, and using the electrolyte solution thus prepared, an evaluation cell and a cylindrical battery were fabricated in the above-described manner.

### COMPARATIVE EXAMPLE 2

A non-aqueous electrolyte solution F was prepared in the same manner as described in Example 1, except that no addition agent was added, and using the electrolyte solution thus prepared, an evaluation cell and a three-electrode test cell were fabricated in the above-described manner.

### COMPARATIVE EXAMPLE 3

A non-aqueous electrolyte solution G was prepared in the same manner as described in Example 2, except that no addition agent was added, and using the electrolyte solution thus prepared, an evaluation cell was fabricated in the above-described manner.

### COMPARATIVE EXAMPLE 4

A non-aqueous electrolyte solution H was prepared in the same manner as described in Comparative Example 1, except that no addition agent was added, and using the electrolyte solution thus prepared, an evaluation cell was fabricated in the above-described manner.

### COMPARATIVE EXAMPLE 5

A mixed solvent of 3:7 volume ratio of ethylene carbonate (EC) and ethyl methyl carbonate (EMC) was used as the solvent, and LiPF₆ was dissolved therein at a concentration of 1 mole/liter. To 100 parts by weight of the resultant solution, 2 parts by weight of vinylene carbonate (VC) was added as an addition agent, to thus prepare a non-aqueous electrolyte solution I. Using the non-aqueous electrolyte solution thus prepared, an evaluation cell and a cylindrical battery were fabricated in the above-described manner.

### COMPARATIVE EXAMPLE 6

A non-aqueous electrolyte solution J was prepared in the same manner as described in Example 1, except that CHF₂COOCH₃ (MFA) having a water content of 48 ppm was used as the solvent and that no addition agent was added, and using the electrolyte solution thus prepared, a three-electrode test cell was fabricated in the above-described manner.

C—V Measurement

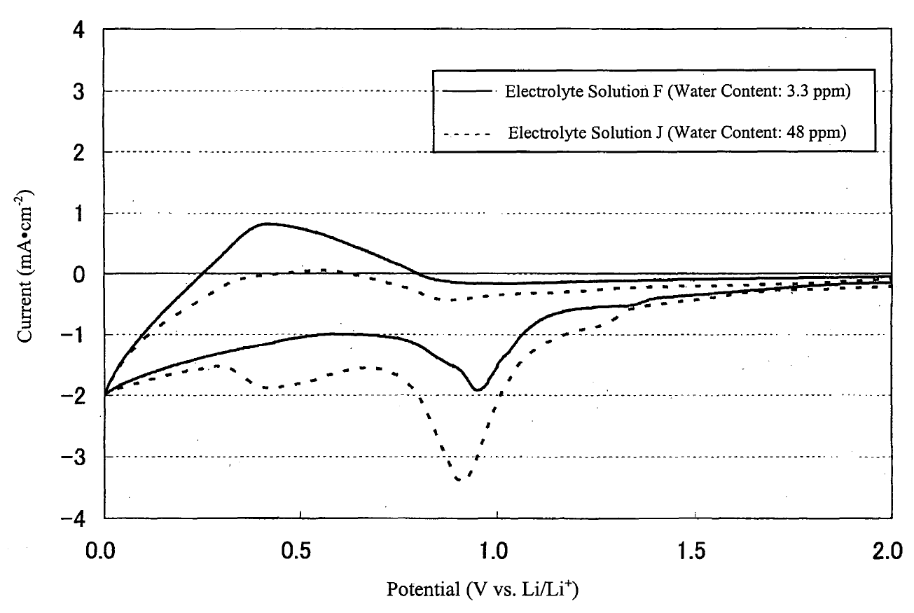

C—V measurement was conducted for the three-electrode test cells with the electrolyte solutions F and J, which used MFA as the solvent, in order to investigate the influence of water content. Each cell was cyclically scanned at a scan speed of 1 mV/s over the range of from 2.0 V to 0 V. The result is shown in FIG. 1. The electrolyte solution F, which has a low water content, shows a current associated with good lithium intercalation and deintercalation subsequent to the formation of the surface film due to the reductive decomposition of the MFA, which is observed at about 1 V (vs. Li/Li⁺). In contrast, the electrolyte solution J, which has a high water content, shows a large current value observed at about 1 V (vs. Li/Li⁺) due to the reductive decomposition of MFA, and exhibits little current that is associated with the subsequent lithium intercalation and deintercalation at about 0.5 V (vs. Li/Li⁺). This demonstrates that the use of the fluorinated ester having a water content of 30 ppm or less according to the present invention makes it possible to form a good surface film on the negative electrode and thereby to lessen the exothermic reaction between the charged negative electrode and the electrolyte solution, and simultaneously achieves good battery performance.

Evaluation of Initial Charge-Discharge Characteristics

The initial charge-discharge characteristics of each of the evaluation cells were evaluated in the following manner. First, each of the evaluation cells was charged at 25° C. with a constant current of 0.25 mA/cm² until the voltage of the test cell reached 0 V. Subsequently, each of the cells was charged again with a constant current of 0.1 mA/cm² until the voltage reached 0 V, to thereby obtain an initial charge capacity C₁. Thereafter, each of the cells was discharged with a constant current of 0.25 mA/cm² until the cell voltage reached 1 V, to thus obtain an initial discharge capacity D1 of the test cell. From the obtained values C₁ and D₁, the initial charge-discharge efficiency (%) for each test cell was determined according to the following equation. The results are shown in Table 1 below.

Initial charge-discharge efficiency (%)=(D₁/C₁)×100

TABLE 1

| | | | Initial charge-discharge |
|---|---|---|---|
| | | Electrolyte | efficiency |
| | | solution | (%) |
| Example 1 | A | MFA + VC + VEC | 91 |
| Example 2 | B | EFA + VC + VEC | 92 |
| Example 3 | C | MFA + VC | 88 |
| Example 4 | D | EFA + VC | 88 |
| Comparative | E | MA + VC + VEC | 94 |
| Example 1 | | | |
| Comparative | F | MFA | 83 |
| Example 2 | | | |
| Comparative | G | EFA | 82 |
| Example 3 | | | |
| Comparative | H | MA | 65 |
| Example 4 | | | |
| Comparative | I | EC/EMC + VC | 94 |
| Example 5 | | | |

As seen from Table 1, Comparative Example 2 (F) and Comparative Example 3 (G), in each of which no addition agent was added and MFA or EFA was respectively used as the solvent, showed low initial charge-discharge efficiencies. This indicates that merely reducing the water content of the fluorinated ester is insufficient. On the other hand, Example 1 (A) through Example 4 (D), in each of which the addition agent(s) was/were added, exhibited good charge-discharge characteristics. In particular, Example 1 (A) and Example 2 (B), in which VEC was added, achieved good charge-discharge characteristics comparable to Comparative Example 1 (E), in which the fluorination was not performed, and Comparative Example 5 (I), which used a conventional carbonate-based electrolyte solution.

Comparative Example 1 (E), in which an addition agent was added to the electrolyte solution of Comparative Example 4 (H) without the fluorination, showed an initial charge-discharge efficiency comparable to that of Comparative Example 5 (I), which used a conventional electrolyte solution, while Example 1 (A) and Example 2 (B) exhibited slightly lower initial charge-discharge efficiencies. This means that the surface film formation originating from the CHF₂COO group partially took place. It also indicates that the addition of a cyclic carbonic ester having an unsaturated C═C bond according to the present invention, particularly the VEC, which decomposes at a similar potential to CHF₂COOR, makes possible the formation of the surface film originating from the CHF₂COO group and at the same time achieves good charge-discharge characteristics.

Evaluation of Thermal Stability

Next, DSC (differential scanning calorimetry) analysis was carried out for each of the evaluation cells, in order to evaluate the reactivity between the charged negative electrode and the electrolyte solution. First, each of the test cells was charged with a constant current of 0.1 mA/cm² to 0 V. Next, each of the test cells was disassembled and the negative electrode mixture was detached off from the copper foil, and DSC analysis was conducted. The results are shown in Table 2.

TABLE 2

| | | | Heat generation |
|---|---|---|---|
| | | | peak temperature |
| | | Electrolyte solution | (° C.) |
| Example 1 | A | MFA + VC + VEC | 273 |
| Example 2 | B | EFA + VC + VEC | 288 |
| Comparative | E | MA + VC + VEC | 216 |
| Example 1 | | | |
| Comparative | I | EC/EMC + VC | 261 |
| Example 5 | | | |

As seen from Table 2, Comparative Example 1 (E), in which the fluorination was not performed, and Comparative Example 5 (I), which used a conventional carbonate-based electrolyte solution, showed low exothermic peak temperatures, and an exothermic reaction between the charged negative electrode and the electrolyte solution took place at an early stage. In contrast, Example 1 (A) and Example 2 (B), in each of which the surface film originating from the CHF₂COO group was formed, showed higher exothermic peak temperatures, and the exothermic reaction between the charged negative electrode and the electrolyte solution was lessened. In particular, it was found that Example 2 (B), which used EFA, showed the highest exothermic peak temperature. It is believed that this is because EFA, which has a higher boiling point than MFA, shows a lower reactivity at high temperatures, although the details of the reason are not yet clear.

Evaluation of Storage Performance in a Charged State

Storage performance of each of the 18650 size cylindrical non-aqueous electrolyte secondary batteries fabricated in the foregoing manners was evaluated in the following manner. Each of the batteries was charged at 25° C. with a constant current (0.2 C) and a constant voltage (cutoff at 0.02 C) to 4.2 V, and then was discharged with a constant current (0.2 C) to 2.75 V, to thus obtain D_{before} (discharge capacity before storage). Subsequently, each battery was charged with a constant current (0.2 C) and a constant voltage (cutoff at 0.02 C) to 4.2 V, and thereafter was stored for 10 days in a constant temperature bath at 60° C. Each of the batteries after the storage test was discharged with a constant current (0.2 C) to 2.75 V, and then charged with a constant current (0.2 C) and a constant voltage (cutoff at 0.02 C) to 4.2 V. Thereafter, each battery was discharged with a constant current (0.2 C) to 2.75 V, to thus obtain D_{after} (discharge capacity after storage). For each battery, the capacity recovery ratio (%) after storage was obtained from the just-described discharge capacities D_{before} and D_{after}. The results are shown in Table 3.

Capacity recovery ratio after storage (%)=(D_{after}/D_{before})×100

TABLE 3

| | | | Capacity recovery |
|---|---|---|---|
| | | | ratio after storage |
| | | Electrolyte solution | (%) |
| Example 1 | A | MFA + VC + VEC | 92 |
| Example 2 | B | EFA + VC + VEC | 90 |
| Comparative | E | MA + VC + VEC | — |
| Example 1 | | | |
| Comparative | I | EC/EMC + VC | 93 |
| Example 5 | | | |

Referring to Table 3, with Comparative Example 1 (E), in which the fluorination was not performed, gas generation occurred during the charge-discharge test due to the reaction between the negative electrode and the electrolyte solution, which made the further test impossible. In contrast, in Example 1 (A) and Example 2 (B), in each of which the surface film originating from the CHF₂COO group was formed, the capacity recovery ratios after storage were comparable to that of Comparative Example 5 (I), which used a conventional carbonate-based electrolyte solution, because a good surface film was formed on the negative electrode surface. This demonstrates that Example 1 (A) and Example 2 (B) have good storage performance.

As has been described thus far, the exothermic reaction between the charged negative electrode and the electrolyte solution can be lessened while good battery performance is assured, by using the non-aqueous electrolyte solution for a secondary battery that contains, in the solvent, a cyclic carbonic ester having an unsaturated C═C bond and a fluorinated ester having a water content of 30 ppm or less and represented by the chemical formula CHF₂COOR, where R is an alkyl group having 1 to 4 carbon atoms or a halogen-atom-substituted alkyl group having 1 to 4 carbon atoms.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

This application claims priority of Japanese patent application No. 2006-036481 filed Feb. 14, 2006, which is incorporated herein by reference.

What is claimed is:

1. A non-aqueous electrolyte solution for a secondary battery, comprising:
a lithium salt as an electrolyte; and
a solvent containing a cyclic carbonic ester having an unsaturated C═C bond, and a fluorinated ester having a water content of 30 ppm or less and represented by the chemical formula CHF₂COOR, where R is an alkyl group having 1 to 4 carbon atoms or a halogen-atom-substituted alkyl group having 1 to 4 carbon atoms.

2. The non-aqueous electrolyte solution for a secondary battery according to claim 1, wherein R in the fluorinated ester is —CH₃ or —C₂H₅.

3. The non-aqueous electrolyte solution for a secondary battery according to claim 1, wherein R in the fluorinated ester is —C₂H₅.

4. The non-aqueous electrolyte solution for a secondary battery according to claim 1, wherein the cyclic carbonic ester having an unsaturated C═C bond has a reduction potential 0.8 V to 1.2 V with respect to the oxidation-reduction potential of lithium.

5. The non-aqueous electrolyte solution for a secondary battery according to claim 2, wherein the cyclic carbonic ester having an unsaturated C═C bond has a reduction potential 0.8 V to 1.2 V with respect to the oxidation-reduction potential of lithium.

6. The non-aqueous electrolyte solution for a secondary battery according to claim 1, wherein the cyclic carbonic ester having an unsaturated C═C bond comprises vinyl ethylene carbonate.

7. The non-aqueous electrolyte solution for a secondary battery according to claim 2, wherein the cyclic carbonic ester having an unsaturated C═C bond comprises vinyl ethylene carbonate.

8. The non-aqueous electrolyte solution for a secondary battery according to claim 1, wherein the cyclic carbonic ester having an unsaturated C═C bond comprises vinylene carbonate.

9. The non-aqueous electrolyte solution for a secondary battery according to claim 2, wherein the cyclic carbonic ester having an unsaturated C═C bond comprises vinylene carbonate.

10. The non-aqueous electrolyte solution for a secondary battery according to claim 1, wherein the fluorinated ester represented by the chemical formula CHF₂COOR, where R is an alkyl group or a halogen-atom-substituted alkyl group, is contained in an amount of 20 volume % or greater of the total volume of the solvent.

11. The non-aqueous electrolyte solution for a secondary battery according to claim 2, wherein the fluorinated ester represented by the chemical formula CHF₂COOR, where R is an alkyl group or a halogen-atom-substituted alkyl group, is contained in an amount of 20 volume % or greater of the total volume of the solvent.

12. The non-aqueous electrolyte solution for a secondary battery according to claim 1, wherein the cyclic carbonic ester having an unsaturated C═C bond is contained in an amount of 0.1 to 10 parts by weight with respect to 100 parts by weight of the electrolyte solution.

13. The non-aqueous electrolyte solution for a secondary battery according to claim 9, wherein the cyclic carbonic ester having an unsaturated C═C bond is contained in an amount of 0.1 to 10 parts by weight with respect to 100 parts by weight of the electrolyte solution.

14. A non-aqueous electrolyte secondary battery comprising:
a positive electrode;
a negative electrode; and
a non-aqueous electrolyte solution according to claim 1.

15. A non-aqueous electrolyte secondary battery comprising: a
positive electrode;
a negative electrode; and
a non-aqueous electrolyte solution according to claim 2.

16. A non-aqueous electrolyte secondary battery comprising:
a positive electrode;
a negative electrode; and
a non-aqueous electrolyte solution according to claim 13.

17. The non-aqueous electrolyte secondary battery according to claim 16, wherein the negative electrode contains, as a negative electrode active material, a carbon material having an R value (I_{D}/I_{G}) of 0.04 to 0.7, the R value calculated from a peak intensity (I_{D}) at peak P_{D} centered at about 1360 cm⁻¹ and a peak intensity (I_{G}) at peak P_{G} centered at about 1580 cm⁻¹, which are determined by laser Raman spectroscopy using an argon laser having a wavelength of 514.5 nm.

18. The non-aqueous electrolyte secondary battery according to claim 16, wherein the positive electrode contains a layered lithium-containing transition metal oxide as a positive electrode active material.

19. The non-aqueous electrolyte secondary battery according to claim 17, wherein the positive electrode contains a layered lithium-containing transition metal oxide as a positive electrode active material.

20. The non-aqueous electrolyte secondary battery according to claim 17, wherein the lithium-containing transition metal oxide is lithium cobalt oxide.
